(19) United States
(12) Patent Application Publication
(10) Pub. No.: US 2005/0250545 A1
(43) Pub. Date: Nov. 10, 2005

(54) Modular connection system

(75) Inventors: James L. Parker, Carson City, NV (US); John R. Zurwell, Reno, NV (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: InterPlex International, LLC

(21) Appl. No.: 11/123,481

(22) Filed: May 6, 2005

Related U.S. Application Data
(60) Provisional application No. 60/569,784, filed on May 10, 2004.

(51) Int. Cl. H04M 1/00

(52) U.S. Cl. 455/562.1; 455/550.1

(57) ABSTRACT

A modular connection system may be used to construct a system for deploying one or more objects. The modular connection system may be used to construct a mounting system to position one or more objects in various positions relative to a support surface. Also, the modular connection system may be used to construct a conduit system to enclose or otherwise house at least a portion of one or more objects. The modular connection system may be used to construct other suitable systems.

### CROSS-REFERENCE TO RELATED APPLICATIONS

This application claims the benefit of and priority to U.S. provisional patent application Ser. No. 60/569,784, filed May 10, 2004 and entitled MODULAR MAST SYSTEM, which is hereby incorporated by reference herein.

### BACKGROUND OF THE INVENTION

1. Field of the Invention

The present invention generally relates to modular connection systems, mounting systems, and to conduit systems.

2. Background Technology

Technology is increasingly moving from wired networks to wireless networks. Cellular telephones, computers, personal digital assistants are examples of devices that are often able to access wireless networks. Some of these devices can be used with either wired or wireless networks. While wired networks have certain benefits, wireless networks also have advantages.

Wireless networks, for instance, promote portability, easy access, and flexibility. For example, users of wireless networks are not tied to a particular location. A user can simply transport their device from one location to the next and access the network without having to reconnect their device to a wired network.

The ability to access a wireless network, however, is often dependent on the wireless network itself. Antennas and other equipment are often needed to establish and/or access a wireless network. In many wireless networks, antennas are mounted on towers. Antenna towers are tall, expensive, and unsightly. In fact, there is often great resistance from the public to installing more of these large antenna towers.

The resistance is often related to the size, appearance, and cost of the antenna towers. When one considers all of the costs (freight cost, labor, materials) involved in installing an antenna along with the undesirable appearance of the antenna towers, it is not surprising that the people are averse to their presence in their communities. In other words, antenna towers are bulky and unsightly. Existing antenna towers may require special equipment to transport and erect the antenna towers. In addition, specially trained personnel may also be required to install the antenna towers.

In spite of the problems associated with the installation, appearance, and use of antenna towers, antenna towers are an integral part of wireless networks. In fact, the efficiency and accessibility of wireless networks is directly related to the placement and coverage provided by the antenna towers.

### BRIEF SUMMARY OF EMBODIMENTS OF THE INVENTION

A need therefore exists for a solution that eliminates or reduces the disadvantages and problems listed above and other disadvantages and problems.

One aspect is a modular connection system. The modular connection system may be used to construct a mounting system to position one or more objects in various positions relative to a support surface. Also, the modular connection system may be used to construct a conduit system to enclose or otherwise house at least a portion of one or more objects. The modular connection system may be used to construct other suitable systems, if desired.

A further aspect is a modular connection system that may advantageously be used to quickly and easily deploy one or more objects at any desired location and in any desired position. For example, in some embodiments of the invention, the modular connection system may be advantageously used to deploy components of outdoor wireless networks; but the modular connection system may be used to deploy any other objects or components if desired.

Another aspect is a modular connection system that includes a support structure, such as a mast. The mast is preferably sized and configured to support one or more objects at various positions relative to a surface, and the mast preferably includes one or more segments. Adjusting the number of segments may advantageously be used to create a mast having a desired height. The segments preferably may be selectively, adjustably, and/or movably interconnected, which may help allow the segments to independently rotate or otherwise move among in a variety of positions. The independently movable segments may help allow one or more objects supported by the individual segments to be positioned independently in a variety of positions and/or orientations. After being positioned in a desired relative orientation, the segments preferably may be locked or otherwise generally fixed in the desired relative orientation. Further, the segments preferably may be released from the locked or otherwise generally fixed orientation to permit the segments, for example, to be re-positioned in another desired orientation or to be disconnected.

Yet another aspect is a modular connection system that includes a support structure, such as a mast, and one or more mounting members connected the mast. The mast preferably includes one or more segments to which the mounting members preferably may be connected. The mounting members are preferably sized and configured to support one or more objects.

Still another aspect is a modular connection system that includes one or more mounting members preferably sized and configured to be selectively, adjustably, and/or movably connected to a segment of the mast. The mounting members and the segments preferably may be positioned in any desired relative orientation, which may help allow objects supported by the mounting members to be positioned in a variety of positions and/or orientations. After being positioned in a desired relative orientation, the mounting members and the segments preferably may be locked or otherwise generally fixed in the desired relative orientation. Further, the mounting members and the segments preferably may be released from the locked or otherwise generally fixed orientation to permit the mounting members and the segments, for example, to be re-positioned in another desired orientation or to be disconnected.

A further aspect is a modular connection system that includes one or more mounting members preferably sized and configured to be selectively, adjustably, and/or movably connected to one or more objects. The mounting members and the objects preferably may be positioned in any desired relative orientation, which may help allow the objects supported by the mounting members to be positioned in a variety of positions and/or orientations. After being positioned in a desired relative orientation, the mounting members and the objects preferably may be locked or otherwise generally fixed in the desired relative orientation. Further, the mounting members and the objects preferably may be released from the locked or otherwise generally fixed orientation to permit the mounting members and the objects, for example, to be re-positioned in another desired orientation or to be disconnected.

Another aspect is a conduit system to, for example, enclose or otherwise house one or more objects. The conduit system may advantageously help a person quickly and easily deploy one or more objects at any desired location and in any desired position. To enclose or otherwise house the one or more objects, some or all of the components of the conduit system preferably include at least one chamber or other generally hollow interior portion. These chambers or generally hollow interior portions may be used to construct at least one conduit sized and configured to enclose or otherwise house the one or more objects.

These and other aspects, features and advantages of the present invention will become more fully apparent from the following detailed description of preferred embodiments and appended claims.

### BRIEF DESCRIPTION OF THE DRAWINGS

The appended drawings contain figures of preferred embodiments to further clarify the above and other aspects, advantages and features of the present invention. It will be appreciated that these drawings depict only preferred embodiments of the invention and are not intended to limits its scope. The invention will be described and explained with additional specificity and detail through the use of the accompanying drawings in which:

FIG. 1 is a side view of an exemplary embodiment of a modular connection system;

FIG. 2 is a cross-sectional view of an exemplary embodiment of a segment of the modular connection system shown in FIG. 1;

FIG. 3 is a cross-sectional view of another exemplary embodiment of a segment of the modular connection system shown in FIG. 1;

FIG. 4 is a cross-sectional view of yet another exemplary embodiment of a segment of the modular connection system shown in FIG. 1;

FIG. 5 is a cross-sectional view of an exemplary connection between segments shown in FIG. 1;

FIG. 6 is a side view of an exemplary embodiment of the modular connection system shown in FIG. 1, illustrating a plurality of mounting members supporting a plurality of objects;

FIG. 7 is a cross-sectional view of an exemplary connection between a segment and a mounting member shown in FIG. 6;

FIG. 8 is a side view of an exemplary embodiment of a segment section that may be used to construct at least a portion of a segment of the modular connection system shown in FIG. 1;

FIG. 9 is a side view of another exemplary embodiment of a segment section that may be used to construct at least a portion of a segment of the modular connection system shown in FIG. 1;

FIG. 10 is a side view of yet another exemplary embodiment of a segment section that may be used to construct at least a portion of a segment of the modular connection system shown in FIG. 1;

FIG. 11 is a side view of an exemplary embodiment of a container that may be connected to the modular connection system shown in FIG. 1; and

FIG. 12 is a side view of the container shown in FIG. 11 connected to the segment section shown in FIG. 10.

### DETAILED DESCRIPTION OF THE PREFERRED EMBODIMENTS

The present invention is generally directed towards a modular connection system. The modular connection system may be used to construct a mounting system to position one or more objects in various positions relative to a support surface. Also, the modular connection system may be used to construct a conduit system to enclose or otherwise house at least a portion of one or more objects.

In one preferred embodiment, the modular connection system may be used to position and/or house at least one power-consuming device and/or at least one power-providing device. This may advantageously help a person quickly and easily deploy one or more power-consuming devices and/or one or more power-providing devices at any desired location and in any desired position. For example, in some embodiments of the invention, the modular connection system may be advantageously used to deploy components of outdoor wireless networks—as discussed in further detail below. But the embodiments of the present invention, of course, are not limited to outdoor wireless networks, to wireless networks, or even to networks.

Further, the embodiments of the present invention are not limited to modular connection systems. For example, it will be understood—in light of the present disclosure—that the mounting systems disclosed in this application can be successfully used within a non-modular system. Likewise, it will be understood—in light of the present disclosure—that the conduit systems disclosed in this application can be successfully used within a non-modular system. Further, the embodiments of the present invention are not limited to mounting systems or to conduit systems. It will be understood—in light of the present disclosure—that the systems disclosed in this application can be successfully used within other contexts.

Additionally, to assist in the description of the modular connection system, words such as top, bottom, upper, lower, front, rear, right and left may be used to describe the accompanying figures. It will be appreciated, however, that embodiments of the present invention can be located in a variety of desired positions—including various angles, sideways and even upside down. It will also be appreciated that the accompanying figures are not necessarily drawn to scale. A detailed description of the modular connection system now follows.

Support Structure

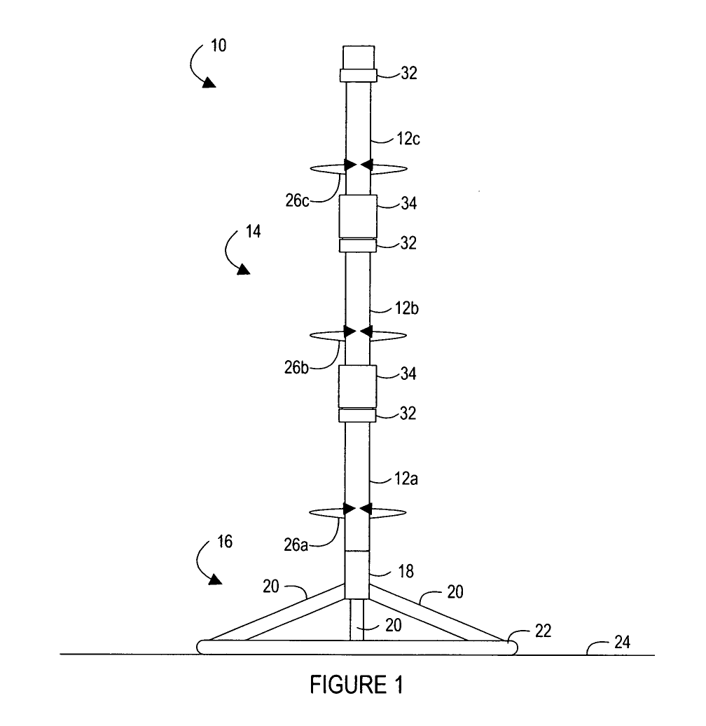

As shown in FIG. 1, a modular connection system 10 may comprise a mounting system. The modular connection system 10 may include one or more segments 12, which may be used to construct a mast or other support structure 14. The mast 14 is preferably sized and configured to support one or more objects at various positions relative to a surface. For example, to support one or more objects at various positions relative to a surface, the mast 14 may be connected to the surface, and one or more objects may be connected to the mast 14. In one embodiment, a segment 12 may be about 2 feet (about 0.6 meters) in length and about 2 to about 3 inches (about 5 to about 7.6 centimeters); however, the segments 12 may be between about 1 to about 3 feet (about 0.3 to about 0.9 meters) or may have larger or smaller dimensions, for example, upon the particular configuration of the mast 14. Further, the segments 12 may the same, similar, or entirely different dimensions if desired.

The mast 14 may be generally upwardly oriented and may have a generally post-shaped configuration; however, the mast 14 may be positioned in other orientations and may have other suitable shapes and configurations. It will be appreciated that there is virtually no limit to the number and types of objects that the modular connection system 10 may support; however, some exemplary configurations will be discussed in further detail below—any components of which may be supported by the modular connection system 10.

Base

As shown in FIG. 1, the modular connection system 10 may include a base 16, which may be sized and configured to secure the mast 14 in a generally stable position. The mast 14 may be attached to at least a portion of the base 16. For example, the base 16 may include an attachment portion 18 to which the mast 14 may be attached. The base 16 may also include one or more legs or braces 20, which may be connected to the attachment portion 18. The braces 20 are advantageously sized and configured to help secure the mast 14 and/or the attachment portion 18 in a generally stable position. In particular, the base 16 preferably includes three, four, or more braces 20 that are substantially equally spaced apart.

As shown in FIG. 1, the base 16 may include a bottom portion 22. The braces 20 may be connected to the bottom portion 22, which may also help secure the mast 14 and/or the attachment portion 18 in a generally stable position. However, the base 16 does not require a bottom portion 22, and the braces 20 may directly contact a support surface 24. Further, the base 16 does not require any braces 20, depending upon the particular configuration of the base 16 and/or the mast 14.

One or more of the braces 20 may be extensible, which may help accommodate support surfaces of various slopes and/or irregular shapes. For example, a brace 20 may move between a first position in which the brace 20 has a first length and a second position in which the brace has a second, different length. Accordingly, with the braces 20 having selectively adjustable lengths, the braces 20 may have varying lengths to accommodate various slopes. One or more of the braces 20 may be collapsible, which may help accommodate storage of the base 16. For example, a brace 20 may move between a first, collapsed or storage position and a second, extended or use position.

The base 16 may include a chamber or other generally hollow interior portion that is sized and configured to receive a ballast material, such as water, sand, gravel, and the like. Thus, the base 16 may advantageously include a ballast material installed within the generally hollowing interior portion—allowing the base to further secure the mast 14 in a generally stable position. For example, at least a portion of the braces 20, at least a portion of the bottom portion 22, and/or at least a portion of the attachment portion 18 may include a chamber or other generally hollow interior portion that is sized and configured to receive a ballast material. The generally hollow interior portions of the braces 20, the bottom portion 22, and the attachment portion 18 may be integrally formed in the braces 20, the bottom portion 22, and the attachment portion 18, respectively, during a molding process or other manufacturing process. However, the base 16, or any portion thereof, does not require any chamber or generally hollow interior portion.

The attachment portion 18, the braces 20, and the bottom portion 22 of the base 16 may be integrally formed as part of a unitary, one-piece construction during a molding process or other manufacturing process. Advantageously, the unitary, one-piece base 16 may be manufactured more quickly because it requires fewer steps. But the base 16 does not require a unitary, one-piece construction, and the base 16 may comprise, for example, a plurality of interconnected, separately formed components.

As shown in FIG. 1, the base 16 may rest upon the support surface 24; however, the base may hang from and/or be connected to the support surface 24 in any other suitable fashion. The support surface 24 is preferably generally horizontal, and the base 16 is preferably positioned on top of the support surface 24. However, the support surface 24 may be generally vertically sloped or sloped at any other angle. Further, all or at least a portion of the base 16 and/or all or at least a portion of the mast 14 may be positioned beneath the support surface 24 or at any other suitable position relative to the support surface 24—depending upon the particular configuration of the modular connection system 10. Thus, the mast 14 and/or the base 16 may be connected to walls, ceilings, and/or other surfaces of structures as desired—using, for example, the connectors 32 and 34 describe below or any other suitable means.

Selective, Adjustable, Movable Connection for Support Structure and Base

As shown in FIG. 1, the mast 14 may be sized and configured to be selectively, adjustably, and/or movably connected to the base 16. Because the mast 14 may be selectively and/or adjustably connected to the base 16, the mast 14 and the base 16 may be positioned in any desired relative orientation. Advantageously, this may help allow objects supported by the mast 14 to be positioned in a variety of positions and/or orientations. In one embodiment, after being positioned in a desired relative orientation, the mast 14 and the base 16 may be locked or otherwise generally fixed in the desired relative orientation. In a further embodiment, the mast 14 and the base 16 may be released from the locked or otherwise generally fixed orientation to permit the mast 14 and the base 16, for example, to be re-positioned in another desired orientation or to be disconnected. It will be appreciated, however, that the mast 14 and the base 16 need not be selectively, adjustably, or movably connected.

In one embodiment, the mast 14 and the base 16 may be sized and configured to, for example, engage each other using a friction fit, a snap fit, and/or an interference fit, and the friction fit, the snap fit, and/or the interference fit may be used to provide a self-locking feature to permit the mast 14 and the base 16 to be remain in a generally fixed position once manually positioned. In one embodiment, the mast 14 may connect to the base 16 using a ball-and-socket joint (or other suitable connection) sized and configured to permit at least some movement in every direction, at least some movement in the three axes to provide three-axis movement, and/or at least some movement in some or all of the three axes. In one embodiment, the mast 14 may connect to the base 16 using a connector 32 and a connector 34 (FIG. 4), discussed in further detail below.

Selective, Adjustable, Movable Connection for Segments

As mentioned above, the mast 14 may include a plurality of segments 12. The segments 12 may be sized and configured to be selectively, adjustably, and/or movably interconnected. For example, as shown in FIG. 1, the segment 12a may be selectively, adjustably, and/or movably connected to the segment 12b, and the segment 12b may be selectively, adjustably, and/or movably connected to the segment 12c. Thus, the segment 12a, the segment 12b, and the segment 12c may be positioned in any desired relative orientation with respect to each other. Preferably, the segment 12a, the segment 12b, and the segment 12c may independently rotate or otherwise move as shown by arrow 26a, arrow 26b, and arrow 26c, respectively. Because the individual segments 12 may independently move among in a variety of positions, this may help allow one or more objects supported by the individual segments 12 to be positioned independently in a variety of positions and/or orientations. In one embodiment, after being positioned in a desired relative orientation, the segments 12 may be locked or otherwise generally fixed in the desired relative orientation. In a further embodiment, the segments 12 may be released from the locked or otherwise generally fixed orientation to permit the segments 12, for example, to be re-positioned in another desired orientation or to be disconnected. It will be appreciated, however, that the segments 12 need not be selectively, adjustably, or movably interconnected. It will also be appreciated that the mast 14 may include fewer or more segments 12, depending upon the particular configuration of the mast 14; and that the number of segments 12 may be altered to form a mast 14 or a modular connection system 10 of a desired, adjustable height.

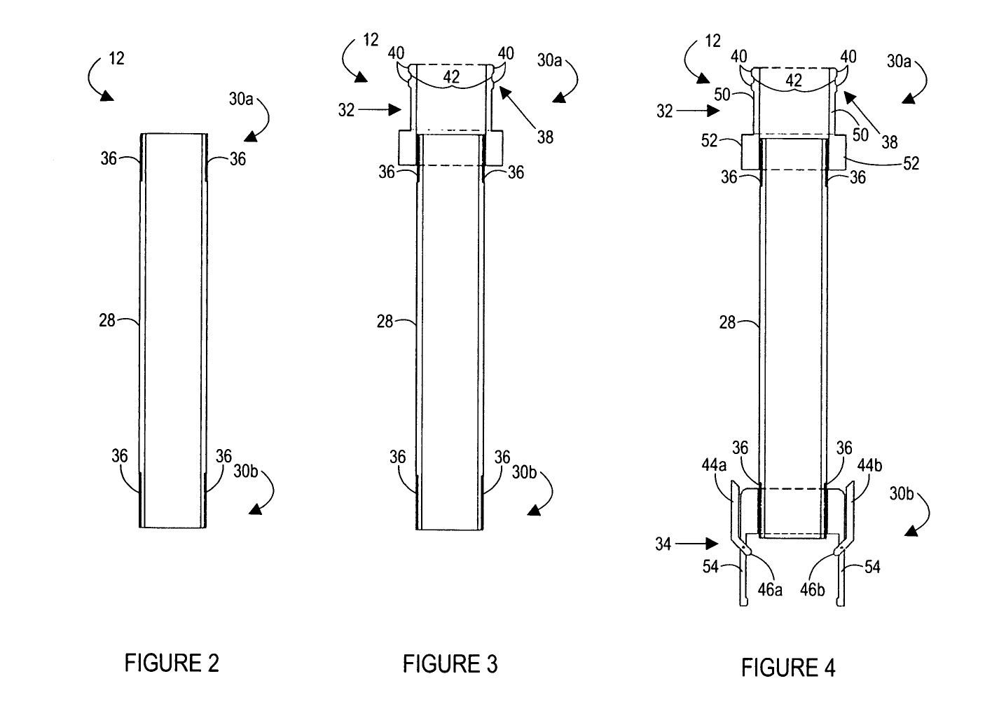

As shown in FIGS. 2-4, the segments 12 may include a body portion 28 and one or more attachment portions 30. The segments 12 preferably include a first, upper attachment portion 30a and a second, lower attachment portion 30b—however, the segments 12 may include fewer or more attachment portions in any desired location. The attachment portions 30 of the segments 12 may be sized and configured to be selectively, adjustably, and/or movably connected to the attachment portion 18 of the base 16 and/or to the attachment portions 30 of other segments 12 in any desired relative orientation. Further, the attachment portions 30 may be sized and configured to be locked or otherwise generally fixed in the desired relative orientation. For example, as shown in FIGS. 1-4, the attachment portion 18 of the base 16 may be connected to the attachment portion 30b of the segment 12a, the attachment portion 30a of the segment 12a may be connected to the attachment portion 30b of the segment 12b, and the attachment portion 30a of the segment 12b may be connected to the attachment portion 30b of the segment 12c. It will be appreciated, however, that the attachment portions 30 need not be selectively, adjustably, or movably connectable.

In one embodiment, the segments 12 may be sized and configured to, for example, engage each other using a friction fit, a snap fit, and/or an interference fit, and the friction fit, the snap fit, and/or the interference fit may be used to provide a self-locking feature to permit the segments 12 to be remain in a generally fixed position once manually positioned. In one embodiment, the segments 12 may be connected using a ball-and-socket joint (or other suitable connection) sized and configured to permit at least some movement in every direction, at least some movement in the three axes to provide three-axis movement, and/or at least some movement in some or all of the three axes. In one embodiment, the segments 12 may be connected using a connector 32 and a connector 34 (FIG. 4), discussed in further detail below.

Exemplary Connectors

As shown in FIGS. 2-4, the attachment portions 30 may include one or more connectors. For example, the attachment portion 30a may include a connector 32, and the attachment portion 30b may include a connector 34. In one embodiment, the connector 32 and the connector 34 may be connected to the body 28 of the segment 12. For example, the body 28 of the segment 12 may include threads 36, and the connector 32 and the connector 34 may include corresponding threads sized and configured to be threadably connected to the threads 36. It will be appreciated that the connector 32, the connector 34, or both may be connected to the body 28 of the segment 12 using one or more mechanical fasteners, threads, adhesives, and/or any other suitable method.

Preferably, the connector 32 and the connector 34 may be selectively connected and disconnected from the body 28 of the segment 12 to optionally permit a variety of connectors to be interchangeably connected to the body 28. For example, while the segment 12 may include the body 28 without any connectors 32 and 34 as shown in FIG. 2, the segment may include a body 28 and one connector, such as a connector 32 (FIG. 3) or a connector 34 (not shown). Further, for example, the segment may include a body 28 and two or more connectors, such as a connector 32 and a connector 34 (FIG. 3), two or more connectors 32 (not shown), two or more connectors 34 (not shown), or any other suitable combination of connectors 32 and/or connectors 34. In one embodiment, the body 28 may include a two or more interchangeable sets of threads, and any suitable combination of connectors 32 and/or connectors 34 may be sized and configured to be interchangeably connected to the interchangeable sets of threads.

Because a variety of the connectors may be interchangeably connected to the body 28, the body 28 and the connectors may be sold separately to allow customers to build segments to their desired configurations. Further, because a variety of connectors may be interchangeably connected to the body 28, a manufacturer may manufacture segments (as needed) in response to customer's specific orders without requiring excessive storage for unordered or less popular segment configurations. However, the connectors 32 and 34 need not be selectively connected and disconnected from the body 23 and need not be interchangeably connected to the body 28. Further, the connector 32, the connector 34, and/or any portion thereof may formed integrally with the body 28 of the segment 12 as part of a unitary, one-piece construction during a molding or other manufacturing process.

The connectors 32 of the segments 12 may be sized and configured to be selectively, adjustably, and/or movably connected to the connectors 34 of other segments 12 in any desired relative orientation. Further, the connectors 32 and 34 may be sized and configured to be locked or otherwise generally fixed in the desired relative orientation. For example, as shown in FIG. 1, the connector 32 of the segment 12a may be connected to the connector 34 of the segment 12b, and the connector 32 of the segment 12b may be connected to the connector 34 of the segment 12c. It will be appreciated, however, that the connectors 32 and 34 of the segments 12 need not be selectively, adjustably, or movably connectable.

In one embodiment, the segments 12 may include one or more locking members. The locking members are preferably sized and configured to lock or otherwise generally fix the segments 12, the connectors 32 and 34, and/or the attachment members 30 in a desired orientation. The locking members may include, for example, one or more inwardly extending portions (such as notches, indentations, grooves, channels, other recesses, and the like) and/or one or more outwardly extending portions (such as bumps, humps, protrusions, ridges, flanges, other projections, and the like). At least a portion of a first locking member is preferably sized and configured contact, abut, or otherwise engage at least a portion of at least one other locking member to help lock or otherwise generally fix the segments 12, the connectors 32 and 34, and/or the attachment members 30 in a desired orientation. The locking members may be sized and configured to, for example, engage each other using a friction fit, a snap fit, and/or an interference fit. Further, the locking members may be sized and configured to, for example, engage each other using a cam-type coupling. For example, in one embodiment, the sections 12 of the mast 14 may be connected using a locking, cam-type coupling as described in U.S. Pat. No. 6,089,619, entitled LOCKING CAM-TYPE COUPLING and issued Jul. 18, 2000 to Michael A. Goda, which is hereby incorporated by reference herein. In one embodiment, the sections 12 of the mast 14 may be connected using a locking, cam-type coupling such as the GATOR LOCK® GREEN ARM cam lever couplings commercially available from Green Leaf, Inc. having corporate offices at 11144 Toney Road, Fontanet, Indiana 47851.

In greater detail, as shown in FIGS. 3-5, the connector 32 may include a locking member 38, which may include a pair of outwardly extending portions 40 and an inwardly extending portion 42. The inwardly extending portion 42 may be disposed at least partially between the pair of outwardly extending portions 40. The outwardly extending portions 40 and the inwardly extending portion 42 preferably extend along all or at least a portion of an outer surface of the connector 32 to help lock or otherwise generally fix the segments 12, the connectors 32 and 34, and/or the attachment members 30 in a variety of desired orientations. Also, as shown in FIGS. 3-5, the connector 34 may include one, two, or more locking members. For example, the connector 34 may include a first locking arm 44a and a second locking arm 44b. At least a portion of the locking arm 44a may comprise a locking member 46a, and at least a portion of the locking arm 44b may comprise a locking member 46b. Thus, at least a portion of a first segment 12, such as the locking arms 44 of the connector 34, preferably may engage at least a portion of a second segment 12, such as the locking member 38 of the connector 32.

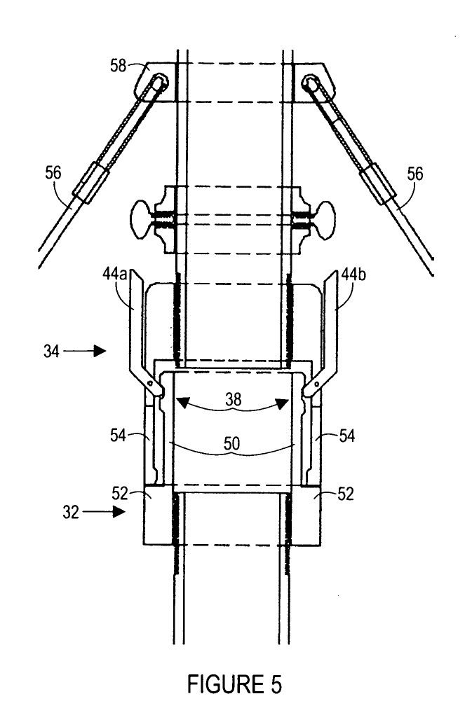

In particular, as indicated by the arrows 48, the locking arms 44a and 44b may pivot or otherwise move from a first, unlocked position (such as shown in FIG. 5) to a second, locked position (not shown). When the locking arms 44 are in the second position, at least a portion of the locking arms 44 preferably contact, abut, or otherwise engage at least a portion of the locking member 38 to help lock or otherwise generally fix the segments 12, the connectors 32 and 34, and/or the attachment members 30 in a desired orientation. When the locking arms 44 are in the second position (such as shown in FIG. 5), the segments 12, the connectors 32 and 34, and/or the attachment members 30 preferably may, for example, rotate or otherwise move to be re-positioned in another desired orientation or to be disconnected.

In one embodiment, the locking arms 44 of the connector 34 preferably pivot between the first and second positions to provide a cam connection force against at least a portion of the connector 32—such as against the locking member 38, one or more of the outwardly extending portions 40, and/or the inwardly extending portion 42. Also, as shown in FIGS. 4 and 5, the connector 34 preferably includes a pair of generally equally spaced apart locking arms 44. Advantageously, the generally equally spaced apart locking arms 44 may provide a more balanced connection with the connector 32. However, the connector 34 may include one, three, four, or more locking arms 44, which may (but need not) be generally equally spaced apart. Further, the connector 34 does not require any locking arms 44, depending upon the particular configuration of the connector 34.

Also, as the locking arms 44 pivot or otherwise move from the first position to the second position, the locking members 46 preferably move from a first, unlocked position (such as shown in FIG. 5) to a second, locked position (not shown). When the locking members 46 are in the second position, at least a portion of the locking members 46 preferably contact, abut, or otherwise engage at least a portion of the locking member 38 to help lock or otherwise generally fix the segments 12, the connectors 32 and 34, and/or the attachment members 30 in a desired orientation. When the locking members 46 are in the second position (FIG. 5), the segments 12, the connectors 32 and 34, and/or the attachment members 30 preferably may, for example, rotate or otherwise move to be re-positioned in another desired orientation or to be disconnected.

In one embodiment, as shown in FIG. 5, at least a portion of the locking arms 44 may be sized and configured to slidably or otherwise movably couple at least a portion of the locking member 38. In particular, when the locking arms 44 are in the second position (such as shown in FIG. 5), the locking members 46 of the locking arms 44 may be sized and configured to slidably or otherwise movably couple at least a portion of the locking member 38—which may help align the segments 12, the connectors 32 and 34, and/or the attachment members 30 such that they may rotate or otherwise move to a desired orientation.

As also shown in FIGS. 4 and 5, at least a portion of a first segment 12 may be sized and configured to be inserted into a second segment 12 such that they may rotate or otherwise move to a desired orientation. In particular, the connector 32 may include a first, body portion 50 and a second, base portion 52; and the connector 34 may include a first, body portion 54. As shown in FIG. 5, the first portion 54 of the connector 34 may include a generally hollow interior portion sized and configured to receive at least a portion of the body portion 50 of the connector 32. Further, as shown in FIG. 5, at least a portion of the body portion 54 of the connector 34 may rest against, abut, and/or contact the base portion 52 of the connector 52—which may advantageously at least partially restrict relative lateral motion between the first and second segments 12, but at least partially permit relative rotational motion between the first and second segments 12.

As shown in FIGS. 3 and 4, a connector, such as the connector 32, may include one or more generally open ends portions. In one embodiment, a connector, such as the connector 32, may include at least one generally closed end portion (not shown) to permit the connector to act as a cap to generally cover and/or seal the end of the segment 12. Likewise, a segment 12 may include at least one generally closed end portion.

As shown in FIGS. 2-4, the segments 12, the connectors 32 and 34, the body 28, and the attachment portions 30a and 30b preferably have a generally circular cross section. The generally circular cross sections may especially help relative rotational motion between the segments 12. However, the segments 12, the connectors 32 and 34, the body 28, and/or the attachment portions 30a and 30b may have generally square, generally oval, generally rectangular, generally polygonal, generally hexagonal, generally octagonal, generally trapezoidal, generally irregular, or other shaped cross sections. Also, the segments 12, the connectors 32 and 34, the body 28, and/or the attachment portions 30a and 30b may have a generally consistent cross section along their lengths; but may have a varying cross section to allow for a variety of shapes and/or configurations. For example, in one embodiment, the body 28 of a segment 12 may include at least one generally enlarged portion sized and configured to house at least a portion of one or more objects, such as a battery, another power-providing device, or other suitable objects. Further, in one embodiment, the enlarged portion may comprise an intermediate portion larger than, for example, one or more of the attachment portions 30 to permit generally consistent attachment portions but allow for a customized enclosure capability. It will be appreciated that other components of the modular connection system 10 may include such enlarged portions, such as the base 16, the mounting arms 60, or others; however, the modular connection system 10 does not require any such enlarged portions. Also, the segments 12, the connectors 32 and 34, the body 28, and/or the attachment portions 30a and 30b do not require cross sections that facilitate any relative rotational motion between the segments 12.

Exemplary Braces for Support Structure

As shown in FIG. 5, the mast 14 may be further stabilized using one, two, or more braces 56, which may be connected to the mast 14 using a slip ring or other bracket 58 or any other suitable method. The braces 56 preferably comprise generally flexible cables, guy wires, rope, chains, and the like; and the braces 56 preferably may have an adjustable tension. However, the braces 56 need not be flexible and need not have an adjustable tension; and the braces 56 may be rigid, if desired.

Mounting Members

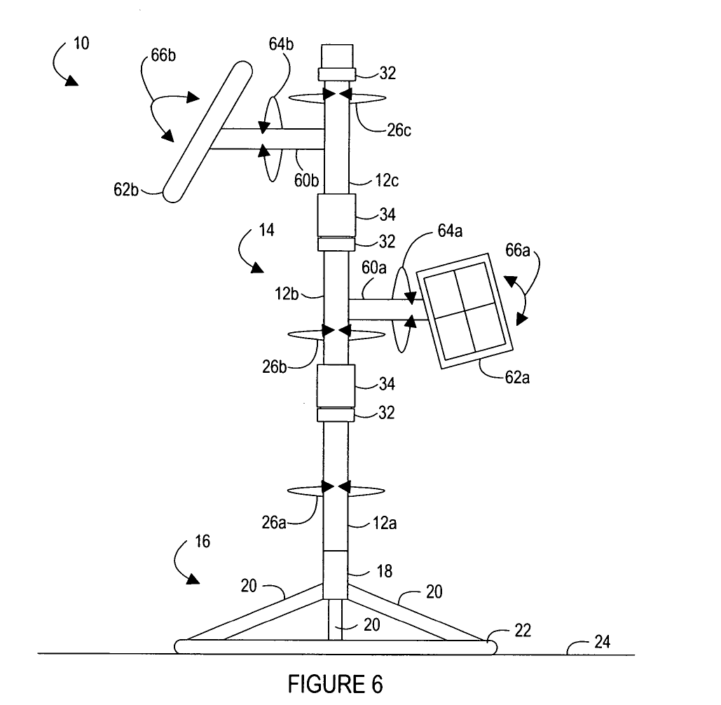

As shown in FIG. 6, a segment 12 may include one or more mounting members 60. For example, the segment 12b may include a mounting member 60a, and the segment 12c may include a mounting member 60b. The mounting members 60 are preferably sized and configured to help position an object 62 (such as a power-consuming device, a power-providing device, or any other object) at any desired orientation and/or at any desired location. This may advantageously help a person quickly and easily deploy the objects 62. The mounting members 60 may be generally horizontally oriented and may have a generally post-shaped configuration; however, the mounting members 60 may be positioned in other orientations and may have a generally L-shaped configuration, a generally Y-shaped configuration, or other suitable shapes and configurations.

Selective, Adjustable, Movable Connection for Mounting Members and Segments

As shown in FIG. 6, the mounting members 60 may be sized and configured to be selectively, adjustably, and/or movably connected to a segment 12 of the mast 14. Because the mounting members 60 may be selectively and/or adjustably connected to a segment 12 of the mast 14, the mounting members 60 and the segments 12 may be positioned in any desired relative orientation. Advantageously, this may help allow objects 62 supported by the mounting members 60 to be positioned in a variety of positions and/or orientations. In one embodiment, after being positioned in a desired relative orientation, the mounting members 60 and the segments 12 may be locked or otherwise generally fixed in the desired relative orientation. In a further embodiment, the mounting members 60 and the segments 12 may be released from the locked or otherwise generally fixed orientation to permit the mounting members 60 and the segments 12, for example, to be re-positioned in another desired orientation or to be disconnected.

For example, as shown in FIG. 6, the segment 12b may be selectively, adjustably, and/or movably connected to the mounting member 60a, and the segment 12c may be selectively, adjustably, and/or movably connected to the mounting member 60b. In one embodiment, a mounting member 60 may connect to a segment 12 using a connector 32 and connector 34 (FIG. 4), which may permit the mounting members 60a and 60b to independently rotate as shown by arrows 64a and 64b. Of course, other connectors or structures may be used to permit the mounting member 60a and 60b to rotate or otherwise move in any other suitable directions. For example, the mounting members 60a, 60b may be connected to the segments 12b, 12c using a ball-and-socket joint (or other suitable connection) sized and configured to permit at least some movement in every direction, at least some movement in the three axes to provide three-axis movement, and/or at least some movement in some or all of the three axes.

It will be appreciated, however, that the mounting members 60 and the segments 12 need not be selectively, adjustably, or movably connected. If desired, the mounting members 60 and/or any portion thereof may be formed integrally with the body 28 of a segment 12 as part of a unitary, one-piece construction during a molding or other manufacturing process; and the mounting members 60 and/or any portion thereof may be permanently connected to a segment 12. Also, it will be appreciated that one, two or more mounting members 60 may be connected to a particular segment 12 to accommodate multiple objects 62; but a segment 12 need not be connected to any mounting members 60. Further, a mounting member 60 may be connected to a particular segment 12 using one or more mechanical fasteners, threads, adhesives, and/or any other suitable method.

In one embodiment, the mounting members 60 and the segments 12 may be sized and configured to, for example, engage each other using a friction fit, a snap fit, and/or an interference fit, and the friction fit, the snap fit, and/or the interference fit may be used to provide a self-locking feature to permit the mounting members 60 and the segments 12 to be remain in a generally fixed position once manually positioned. In one embodiment, the mounting members 60 and the segments 12 may be connected using a connector 32 and a connector 34 (FIG. 4).

Selective, Adjustable, Movable Connection for Mounting Members and Objects

As shown in FIG. 6, the mounting members 60 may be sized and configured to be selectively, adjustably, and/or movably connected to one or more objects 62. Because the mounting members 60 may be selectively and/or adjustably connected to an object 62, the mounting members 60 and the objects 62 may be positioned in any desired relative orientation. Advantageously, this may help allow the objects 62 supported by the mounting members 60 to be positioned in a variety of positions and/or orientations. In one embodiment, after being positioned in a desired relative orientation, the mounting members 60 and the objects 62 may be locked or otherwise generally fixed in the desired relative orientation. In a further embodiment, the mounting members 60 and the objects 62 may be released from the locked or otherwise generally fixed orientation to permit the mounting members 60 and the objects 62, for example, to be re-positioned in another desired orientation or to be disconnected.

For example, as shown in FIG. 6, the object 62a may be selectively, adjustably, and/or movably connected to the mounting member 60a, and the object 62b may be selectively, adjustably, and/or movably connected to the mounting member 60b. In one embodiment, the objects 62a and 62b may independently move as shown by arrows 66a and 66b. Of course, other connectors or structures may be used to the objects 62a and 62b to rotate or otherwise move in any other suitable directions. For example, the objects 62a and 62b may be connected to the mounting members 60a, 60b using a ball-and-socket joint (or other suitable connection) sized and configured to permit at least some movement in every direction, at least some movement in the three axes to provide three-axis movement, and/or at least some movement in some or all of the three axes.

It will be appreciated, however, that the mounting members 60 and the objects 62 need not be selectively, adjustably, or movably connected. If desired, the mounting members 60 and/or any portion thereof may be formed integrally with the objects 62 as part of a unitary, one-piece construction during a molding or other manufacturing process; and the mounting members 60 and/or any portion thereof may be permanently connected to an object 62. Also, it will be appreciated that one, two or more objects 62 may be connected to a particular mounting member 60 to accommodate multiple objects 62; but a mounting member 60 need not be connected to any objects 62. Further, a mounting member 60 may be connected to a particular object 62 using one or more mechanical fasteners, threads, adhesives, and/or any other suitable method.

In one embodiment, the mounting members 60 and the objects 62 may be sized and configured to, for example, engage each other using a friction fit, a snap fit, and/or an interference fit, and the friction fit, the snap fit, and/or the interference fit may be used to provide a self-locking feature to permit the mounting members 60 and the objects 62 to be remain in a generally fixed position once manually positioned. In one embodiment, the mounting members 60 and the objects 62 may be connected using a ball-and-socket joint (or other suitable connection) sized and configured to permit at least some movement in every direction, at least some movement in the three axes to provide three-axis movement, and/or at least some movement in some or all of the three axes. In one embodiment, the mounting members 60 and the objects 62 may be connected using a connector 32 and a connector 34 (FIG. 4).

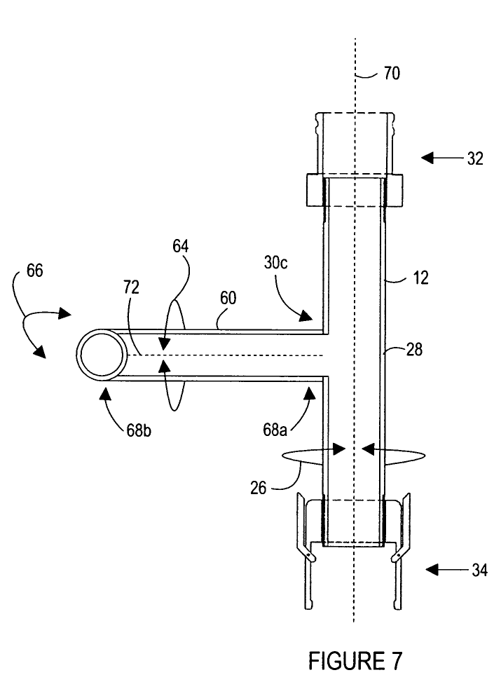

In greater detail, as shown in FIG. 6, a mounting member 60 may include an attachment portion 68a connected to an attachment portion 30c of a segment 12 and an attachment portion 68b connected to an object (not shown), such as the objects 62. As shown in FIGS. 6 and 7, the movement indicated by the arrows 26 may be rotational movement about a generally central axis 70 of the segments 12; and the movement indicated by the arrows 64 may be rotational movement about a generally central axis 72 of the mounting members 60. As shown in FIG. 7, the axis 70 and the axis 72 may be generally perpendicular, but the axis 70 and the axis 72 may be positioned at other angles, if desired. However, the attachment portion 68a of the mounting member 60 may be connected to an attachment portion 30c of the segment using a ball-and-socket joint (or other suitable connection) sized and configured to permit at least some movement in every direction, at least some movement in the three axes to provide three-axis movement, and/or at least some movement in some or all of the three axes. Further, the attachment portion 68b of the mounting member 60 may be connected to an object 62 using a ball-and-socket joint (or other suitable connection) sized and configured to permit at least some movement in every direction, at least some movement in the three axes to provide three-axis movement, and/or at least some movement in some or all of the three axes.

Exemplary Materials

The segments 12, the body portions 28, the connectors 32 and 34, the base 16, the attachment portion 18 of the base 16, the braces 20 of the base 16, the bottom portion 20 of the base 16, the mounting members 60, and/or any other component of the modular connection system 10 may be constructed from plastic, such as, but not limited to, PVC, polypropylene, polyethylene, or any other plastic. The plastic components of the modular connection system 10 are preferably generally non-conductive, non-corrosive, weather resistant, and strong. The plastic components of the modular connection system 10 may advantageously be generally transparent to radio waves to, for example, permit a variety of wireless communications signals. The plastic components of the modular connection system 10 may also be more easily colored for display or camouflage. In one embodiment, the plastic components of the modular connection system 10 may be reinforced with fiberglass fibers (or other reinforcement materials) during a molding process (such as injection molding, pultrusion molding, extrusion molding, or the like) or other manufacturing process to provide additional strength for heavier components.

Advantageously, the plastic components of the modular connection system 10 may be relative lightweight, which may reduce shipping costs and may help make the modular connection system 10 be easier to move, assemble, and/or dissemble. In one embodiment, a segment 12 preferably weighs about 3 pounds; however, the segment may weigh more or less depending, for example, upon the particular materials used to construct the segment and the size of the segment.

It will be appreciated, however, that the components of the modular connection system 10 need not be constructed from plastic; and some or all of the components of the modular connection system 10 may be constructed from metal, aluminum, steel, fiberglass, wood, various composite materials, or other materials having other desired characteristics—depending upon the particular configuration of the modular connection system 10 and/or the particular configuration of the objects being supported and/or housed by the modular connection system.

Conduit System

As mentioned above, the modular connection system 10 may be used as a conduit system to, for example, enclose or otherwise house all or at least a portion of at least one object, such as at least one power-consuming device and/or at least one power-providing device. This may advantageously help a person quickly and easily deploy these objects at any desired location and in any desired position. It will be appreciated that there is virtually no limit to the number and types of objects that the modular connection system 10 may enclose or otherwise house; however, some exemplary configurations will be discussed in further detail below—any components of which may be housed by the modular connection system 10.

To enclose or otherwise house one or more objects, some or all of the components of the modular connection system 10 may include at least one chamber or other generally hollow interior portion. Any combination of these and/or other chambers or other generally hollow interior portions may be used to construct at least one conduit sized and configured to enclose or otherwise house all or at least a portion of one or more objects. In particular, as shown in FIG. 7, the segment 12 may include a chamber or other generally hollow interior portion. For example, some or all of the body 28, the connector 32, and the connector 34 may include a chamber or other generally hollow interior portion. Likewise, as shown in FIG. 7, the mounting member 60 may include a chamber or other generally hollow interior portion. Similarly, as explained above with reference to FIG. 1, the base 16 may include a chamber or other generally hollow interior portion. For example, at least a portion of the braces 20, at least a portion of the bottom portion 22, and/or at least a portion of the attachment portion 18 may include a chamber or other generally hollow interior portion. The generally hollow interior portions of the components of the modular connection system 10 may be integrally formed during a molding process or other manufacturing process. However, the modular connection system 10, or any component thereof, does not require any chamber or generally hollow interior portion.

Exemplary Manufacturing Processes

In some instances, an individual manufacturing process may be inadequate to create desired features in a segment 12 as a whole. Accordingly, to create the desired features, several manufacturing processes may be required—increasing the overall manufacturing costs. Unfortunately, in some instances, even these several manufacturing processes do not consistently yield the desired results.

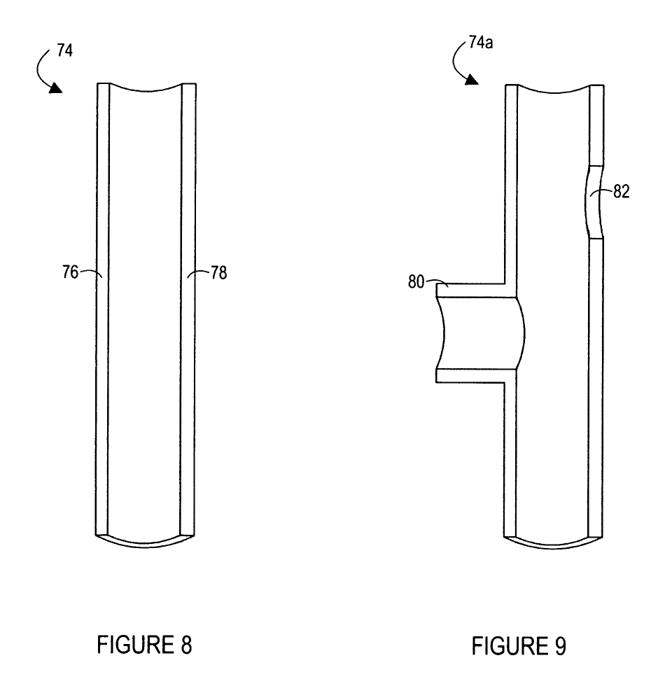

In one embodiment, an exemplary manufacturing process is provided in which a segment 12 may comprise two or more segment sections, such as a segment section 74 shown in FIG. 8. Advantageously, by constructing a segment 12 using two or more segment sections 74 (instead of forming the entire segment 12 as a whole) may permit the segment 12 to more easily and consistently provide particular features. However, the entire segment 12 may be formed as whole—depending, for example, upon the particular features of the segment 12.

In greater detail, the segment sections 74 may be manufactured independently using the same, similar, or entirely different types of manufacturing processes, such as injection molding, extrusion molding, blow molding, rotary molding, compression molding, pultrusion molding, other molding processes, or other manufacturing processes. After independently manufacturing the segment sections 74, the segment sections 74 may be connected to assemble a segment 12 or any portion thereof, such as a body portion 28 of a segment 12. It will be appreciated that the segment sections 74 may be connected using one or more mechanical fasteners, adhesives, a friction fit, a snap fit, an interference fit, and/or any other suitable means for connecting the segment sections 74. In one embodiment, as shown in FIGS. 8-10, a segment section 74 may comprise a longitudinal half of a segment 12 or a body 28 of a segment 12. However, the segment sections 74 may comprise a third, a fourth, or other suitable portion of a segment 12 or a body 28; and a segment or a body could be partitioned in suitable fashions other than longitudinally.

As shown in FIGS. 8-12, the segment sections 74 may include one or more features formed in the segment sections during a manufacturing process. Preferably the features may be integrally formed in the segment section as part of a unitary, one-piece structure during a molding process; however, the features may be formed using other manufacturing processes and may be separately formed after a molding process.

In one embodiment, the segment sections 74 may include a first side or edge portion 76 and a second side or edge portion 78; and the sides 76 and 78 may have complementary features. For example, the sides 76 and 78 may include locking members sized and configured to engage each other (such as one or more inwardly extending portions and one or more complementary outwardly extending portions) using a snap fit, a friction fit, an interference fit, and/or the like. In one embodiment, by advantageously including complementary locking members on generally opposing sides, two or more of the same configuration of segment sections could be used to create a segment 12 or portion thereof—depending, for example, on the particular configuration of the segment 12. Thus, in one embodiment, a only a single configuration for a segment section 74 would be manufactured and stored to create certain configurations of segments 12—which may help simply manufacturing and help maximize storage. Of course, the segment sections 74 need not include complementary portions of any sort; and entirely differently shaped and/or sized segment sections 74 may be used to construct a desired segment 12.

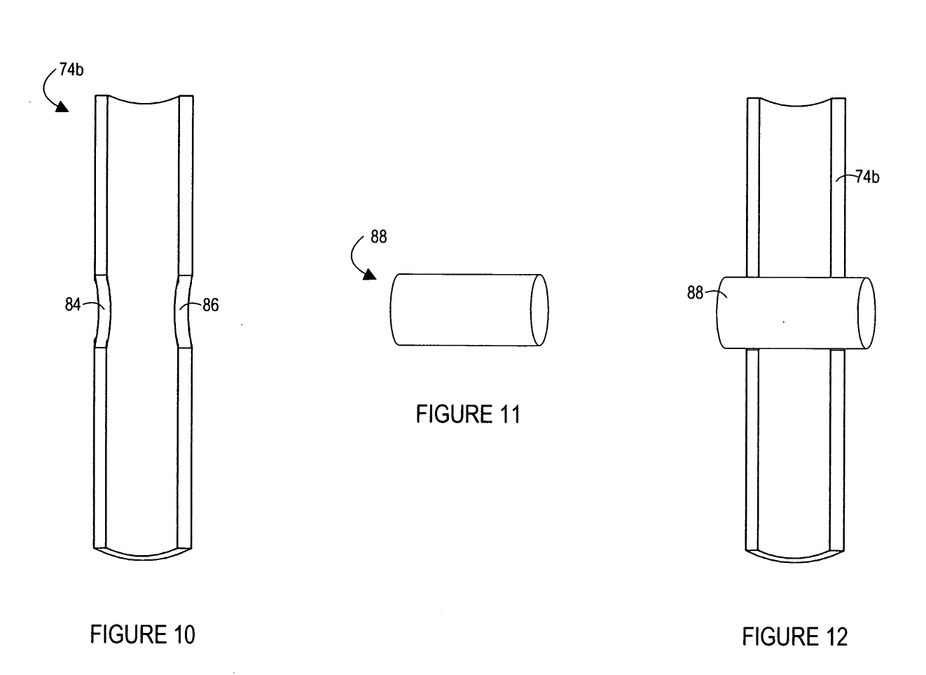

If desired, using segment sections 74 may help provide a segment 12 with a variety of apertures, different wall thicknesses, locking members, threads or other generally universal fittings, connectors, mounting members, other features, or any portions thereof. For example, as shown in FIG. 9, the segment section 74a may include a portion of an extension 80, which may form part of a mounting member 60 and/or part of an aperture providing access to a chamber or other generally hollow interior portion of a segment 12. Also as shown in FIG. 9, the segment section 74b may include a portion 82 of an aperture providing access to a chamber or other generally hollow interior portion of a segment 12. Similarly, as shown in FIG. 10, the segment section 74b may include one or more portions 84, 86 of one or more apertures providing access to a chamber or other generally hollow interior portion of a segment 12. In one embodiment, the end portions of the segment sections 74 may include one or more portions of threads (not shown) such as the threads 36 (FIG. 2). Of course, the segment sections 74 may include all or at least a portion of a variety of features to help construct a segment 12 with desired features; however, the segment 12 does not require any segment sections 74 or any particular features.

Exemplary Container System

As shown in FIG. 1, a container 88 may be provided, and the container 88 may include a chamber or other generally hollow interior portion sized and configured to enclose or otherwise house at least a portion of one or more objects. The container 88 may include one or more access openings for inserting at least a portion of the one or more objects into the container and/or to provide access the objects within the container.

As shown in FIGS. 10-12, the container 88 may be inserted into one or more apertures or other receiving portions formed in a segment 12, which receiving portions may be formed using one or more segment sections 74b. Advantageously, the receiving portions may sized and configured to receive and/or retain at least a portion of the container 88. In one embodiment, the receiving portions may be sized and configured to receive and/or retain at least a portion of the container 88 using a snap fit, a friction fit, an interference fit, or the like; however, the receiving portions may be connected to the container 88 in any other suitable fashion.

It will be appreciated that the segment sections 74 are not necessary to form receiving portions and that the container 88 and/or the receiving portions may have other suitable sizes, shapes, and/or configurations—depending, for example, upon the particular objects housed by the container 88.

In one preferred embodiment, the container 88 may house all or at least a portion of an antenna, a transmitter for the antenna, and a computing device. In a further embodiment, the antenna may be directly connected or indirectly connected to the transmitter; and the computing device may be directly or indirectly connected to the transmitter. It will be appreciated, however, that there is virtually no limit to the number and types of objects that the container 88 may house; however, some exemplary configurations will be discussed in further detail below—any components of which may housed by the container 88.

Exemplary Configurations

The following describes some exemplary configurations of objects and/or systems that may be supported and/or housed by the modular connection system 10. It will be appreciated however that there is virtually no limit to the number and types of objects or systems that the modular connection system 10 may support and/or house. Accordingly, these exemplary configurations are provided for example only—not to limit the scope of the invention in any fashion.

The modular connection system 10 may be used as a mounting system (and/or a conduit system to enclose or otherwise house all or at least a portion of) a variety of objects or components 62, including (but not limited to) electronics; flat-panel LCD televisions and/or monitors (or other televisions and/or monitors); power-providing devices; power consuming devices; peripherals; circuit boards; satellite dishes; temperature-hardened PC boards; temperature-hardened circuit boards; video cameras; Internet controlled video cameras; wireless surveying equipment; monitoring equipment for alternative energy producers; computing devices or systems (such as Linux boxes) optionally with one or more storage devices (such as for recording observations or other data or for other uses); weather monitoring equipment; wind monitoring equipment; global positioning systems/sensors (or other GPS devices); wind generating equipment; motion detectors; wireless antennas; networking components (such as web servers, routers, firewalls, switches, hubs, network interface cards, and the like) and the like; data gathering devices or sensors; data storage devices; other objects; or any combination thereof. It will be appreciated that these components can be combined with a myriad of other components using the modular connection system 10—further enhancing functionality.

As mentioned above, one or more data gathering devices or sensors may be used in the modular connection system 10. In one embodiment, the sensors may include weather sensors, such as wind direction, wind speed, humidity, temperature, incident radiation, precipitation, dust particles sensors, and other weather sensors. In one embodiment, the sensors may monitor fuel. In one embodiment, the sensors may monitor water systems, such as water level of tank and/or a well, location of a water pump, amperage for a component, voltage for a component, rpm of a motor, head pressure at top of a well or other portion of the well, water flow into and/or out of a tank, water flow into and/or out of a well, pH levels, amounts of chemicals or trace elements, viscosity, and others. In one embodiment, various security system sensors, such as infrared motion, visual spectrum motion, acoustic sensors. In one embodiment, the sensors may monitor seismic activity, such as earthquake activity or other forces applied to a surface. It will be appreciated that a myriad of other data gathering devices or sensors may be used with the modular connection system 10.

As mentioned above, the modular connection system 10 may be used as a conduit system to, for example, enclose or otherwise house various objects or components. In one embodiment, the modular connection system 10 may be used as a conduit system to enclose or otherwise house at least a portion of one or more wires (not shown)—allowing some or all of any such wiring to be internal, simplifying assembly and protecting the wiring from the weather or other harm. In one embodiment, the wires may be used as a communications medium to receive incoming communications and/or send outgoing signals, messages, and the like. For example, the modular connection system 10 may support and/or house a first set of one or more electronic components; and the wires may be used as a communications medium to facilitate communication among the first set of electronic components and/or other electronic components, such as external electronic components. In one embodiment, the wires may be used as power cords to provide and/or receive power. For example, the modular connection system 10 may support and/or house at least one power-consuming device and/or at least one power-providing device, and the wires may be connected to the at least one power-consuming device and/or to the at least one power-providing device. It will be appreciated that the wires may be used for other suitable purposes; and that the wires need not be enclosed or otherwise housed by the modular connection system. However, housing the wires may help protect the wires and/or related internal connections (if any) from damage.

In greater detail, power to objects or components 62 supported and/or housed by the modular connection system 10 can be provided using one or more solar panels, wind-power modules, or other power-providing devices—and the power-providing devices themselves may also be (but need not be) supported and/or housed by the modular connection system 10. For example, the object 62b may comprise a power-consuming device, and the object 62a may comprise a solar panel. As mentioned above, one or more wires may couple the power-consuming device 62a and the solar panel 62b to provide power to the power-consuming device 62a. Of course, solar panels are not required and other power-providing devices, such as batteries, may be used. The batteries may, for example, be supported and/or housed by the modular connection system 10.

Because at least one power-consuming device and at least one power-providing device may be supported and/or housed by the modular connection system 10, the modular connection system may advantageously used to allow the at least one power-consuming device to be located in virtually any desired location—independent of any external power supply. Thus, external power sources are not required, although the modular connection system 10 can accommodate such power sources, if desired. Of course, the modular connection system 10 does not require any power-consuming devices or any power-providing devices.

Certain embodiments of the modular connection system 10 may provide further advantages. Because the segments 12 preferably may move independently, the objects 62 supported by the modular connection system 10 may be individually adjusted to face any desired direction in three dimensions or axes. For example, a first antenna mounted to a first segment 12 and a second antenna mounted to a second segment 12 may be positioned to point in the same, similar, or entirely different directions. Additionally, the mounting members 60 may provide additional degrees of movement or orientation for a plurality of objects 62—allowing the plurality of objects 62 to point in the same, similar, or entirely different directions, azimuths, and/or elevations—as desired. Further, as mentioned above, various components of the modular connection system 10 may be locked or otherwise generally fixed in various relative orientation—which may help prevent inadvertent alteration of any 3-axis tuning typically used for antennas, solar panels, satellite dishes, and the like.

In one preferred embodiment, the modular connection system 10 may support and/or house all or at least a portion of an antenna, a transmitter for the antenna, and a computing device. In one embodiment, the antenna may be directly connected or indirectly connected to the transmitter; and the computing device may be directly or indirectly connected to the transmitter. In one embodiment, the antenna, the transmitter, and the computing device may be generally housed by a segment 12. In one embodiment, one or more sensors may be coupled to the computing device to permit the computing device to store and/or generate data from data obtained via the sensors. Advantageously, the computing device may use the transmitter and the antenna to transmit the data via a wireless network or other suitable means of communication.

In one embodiment, the modular connection system 10 may be easily and quickly assembled and/or disassembled by a single person at any location. Advantageously, the may allow the modular connection system 10 to be used and re-used for a variety of different purposes.

In one embodiment, a networking system is provided. The networking system may include the modular connection system 10. The modular connection system 10 may support and/or house at least a portion of an antenna configured to provide wireless access to a network. The antenna preferably provides wireless access from a variety of locations. The modular connection system 10 may be located outdoors to provide an at least partially outdoor wireless network. It will be appreciated, however, that the modular connection system 10 and the antenna need not be located outdoors; and the modular connection system 10 could be used in non-wireless network systems.

Thus, some exemplary embodiments provide an easily erected, inexpensive, modular connection system 10—which may be used to deploy indoor and/or outdoor wireless networks quickly and efficiently. Further, some exemplary embodiments may be lightweight (even portable), reducing the need to construct heavy, permanent antenna towers. Further, some exemplary embodiments of the modular connection system 10 may be more easily transported—such as within a trunk of a standard size automobile.

In one embodiment, the modular connection system 10 may be camouflaged to, for example, help prevent detection of the objects mounted and/or housed by the modular connection system 10. Preventing such detection may help facilitate surveillance or other monitoring (such as for law enforcement activities) and may help prevent theft, which may be especially useful where the particular objects are expensive. In one embodiment, a camouflage housing may be shaped, painted, and/or otherwise configured to camouflage and/or house at least a portion of the modular connection system. For example, one or more of the segments 12 may be disposed within a camouflage housing; and the camouflage housing may be shaped and painted to resemble a rock or other natural feature to camouflage the segments 12 in the outdoors. In one embodiment, the camouflage housing may be constructed using fiberglass or other suitable materials. It will be appreciated that the particular camouflage used may depend, for example, upon the particular location the modular connection system 10 may be used.

In one embodiment, the modular connection system 10 or components thereof (such as the segments 12) may be used as a conduit system for one or more wires, such as those discussed above. Advantageously, the conduit system may be deployed within a house, buildings, and the like to help install networks, electrical wiring, and the like. Further, in one embodiment, the conduit system may be used with insulated concrete forms (ICF)—which generally include a layer including concrete disposed between two layers including insulation materials. Advantageously, the conduit system may be disposed at least partially within one or more the insulation layers.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A modular connection system comprising:
at least one power consuming device;
a support structure supporting the at least one power consuming device relative to a support surface, the support structure including:
a first segment; and
a second segment connected to the first segment;
wherein the first segment and the second segment are sized and configured to be positioned among a plurality of relative rotational positions; and
wherein the first segment and the second segment are sized and configured to be selectively locked at the plurality of relative rotational positions.

2. The modular connection system as in claim 1, wherein the at least one power consuming device includes an antenna configured to provide access to a wireless network.

3. The modular connection system as in claim 1, wherein the at least one power consuming device includes web server.

4. The modular connection system as in claim 1, wherein the at least one power consuming device includes a firewall.

5. The modular connection system as in claim 1, wherein the at least one power consuming device includes at least one of a router, a switch, or a hub.

6. The modular connection system as in claim 1, wherein the at least one power consuming device includes a computing system.

7. The modular connection system as in claim 1, wherein the support structure further includes at least one generally hollow interior portion sized and configured to house at least a portion of the at least one power consuming device.

8. The modular connection system as in claim 1, further comprising:
at least one power providing device, the support structure supporting the at least one power providing device relative to the support surface.

9. The modular connection system as in claim 8, wherein the support structure further includes at least one generally hollow interior portion sized and configured to house at least a portion of the at least one power providing device.

10. The modular connection system as in claim 8, wherein the at least one power providing device includes one or more batteries.

11. The modular connection system as in claim 8, wherein the support structure is a mast.

12. A modular connection system comprising:
a power consuming device;
a first mounting member connected to the power consuming device;
a mast including:
a first segment connected to the first mounting member; and
a second segment connected to the first segment;
wherein the first segment and the second segment are sized and configured to be positioned among a first set of relative positions; and
wherein the first segment and the second segment are sized and configured to be selectively locked at the first set of relative positions.

13. The modular connection system as in claim 12, wherein the first segment and the first mounting member are sized and configured to be positioned among a second set of relative positions and wherein the first segment and the first mounting member are sized and configured to be selectively locked at the second set of relative positions.

14. The modular connection system as in claim 12, wherein the power consuming device and the first mounting member are sized and configured to be positioned among a second set of relative positions and wherein the power consuming device and the first mounting member are sized and configured to be selectively locked at the second set of relative positions.

15. The modular connection system as in claim 12, further comprising:
a power providing device; and
a second mounting member connected to the first power consuming device and connected to the second segment.

16. The modular connection system as in claim 15, wherein the second segment and the second mounting member are sized and configured to be positioned among a second set of relative positions and wherein the second segment and the second mounting member are sized and configured to be selectively locked at the second set of relative positions.

17. The modular connection system as in claim 16, wherein the power providing device and the second mounting member are sized and configured to be positioned among a second set of relative positions and wherein the power providing device and the second mounting member are sized and configured to be selectively locked at the second set of relative positions.

18. A modular connection system configured to support an object relative to a support surface, the modular connection system comprising:
a first mounting member sized and configured to be connected to the object;
a mast including:
a first segment connected to the first mounting member;
a second segment connected to the first segment;
a third segment connected to the second segment;
wherein the first segment and the second segment are sized and configured to be positioned among a first set of relative positions; wherein the first segment and the second segment are sized and configured to be selectively locked at the first set of relative positions; and
wherein the third segment and the second segment are sized and configured to be positioned among a second set of relative positions; wherein the third segment and the second segment are sized and configured to be selectively locked at the second set of relative positions.

19. The modular connection system as in claim 18, wherein the object comprises a computing device.

20. The modular connection system as in claim 18, wherein the object comprises a data gathering device.

21. A method of manufacturing a mast including a plurality of segments, the method comprising:
molding a first segment section via a first molding process, the first segment section including a first portion of a threaded interface;
molding a second segment section via a second molding process, the second segment section including a second portion of a threaded interface;
connecting the first and second mast segment sections with the first and second portions of a threaded interface are operatively aligned.
